(19) United States
(12) Patent Application Publication
(10) Pub. No.: US 2004/0106308 A1
(43) Pub. Date: Jun. 3, 2004

(54) 60-Channel connectors

(76) Inventors: Mao-Hsiung Chen, Tien City (TW); Phuoc-Long Huynh, Cupertino, CA (US)

Correspondence Address: BIRCH STEWART KOLASCH & BIRCH, PO BOX 747, FALLS CHURCH, VA, 22040-0747, US

(21) Appl. No.: 10/307,920

(22) Filed: Dec. 3, 2002

(51) Int. Cl. H01R 12/00

(52) U.S. Cl. 439/79

(57) ABSTRACT

A 60-channel connector comprising a male and a female coupling is proposed. The male and the female coupling have a connection base in form of a D-shaped opening and a D-shaped flange respectively, where both the D-shaped opening and flange are formed correspondingly to become a sleeve-jointing structure for tight combination. Moreover, a plurality of pins in the male coupling and corresponding plugholes in the female coupling are zigzagged horizontally to form a pair of corresponding arrays. The connector is characterized in: a larger contact area of the circular pins and the zigzag arranged pins and plugholes, so that avoiding poor quality of signal transfer, decreasing the pitch between pins, and preventing a faulty connection of the couplings are possible.

### FIELD OF THE INVENTION

This invention relates to a 60-channel connector having circular pins with a larger contact surface and zigzag arranged pins and plugholes in respective arrays to thereby avoid poor quality of signal transfer, decrease the pitch between pins, and prevent the faulty connection of couplings.

### BACKGROUND OF THE INVENTION

A conventional 60-channel connector shown in FIGS. 1, 2, and 3 is mainly comprised of a male coupling 1′ and a female coupling 2′.

The male coupling 1′ can be obtained by extending the front end of a connection base 10′ to hence form a D-shaped opening 12′, to which some metallic conductive lines for signal transmission are provided and extended outwardly from inside thereof to form a plurality of pins 14′ in an array (shown in FIG. 2). The female coupling 2′ mainly consists of a D-flange 22′ formed by extending the front end of a connection base 20′. The D-flange 22′ is a sleeve-jointing structure meant to match exactly with the inner verge of the D-shaped opening 12′ of the coupling 1′, and is perforated outwardly to form a plurality of plugholes 24′ in an array, corresponding to the pins 14′ one to one. A metallic conductive wire is concealed in each plughole 24′ respectively as shown in FIG. 3 for signal transmission through the connection base 20′.

A butt-joint structure can be formed with the pin 14′, which is a flat pin installed slantwise, and the plughole 24′, which is a square tiny hole. However, as the flat pin 14′ cannot be fully and tightly plugged in the plug-hole 24′, poor contact and hence poor signal transmission is liable to happen, in addition to the space waste of the interval arrangement of the flat pins 14′.

Moreover, because the pins in the male coupling and the plugholes in the female coupling are not horizontally and zigzag aligned in respective arrays, the connector is not provided with the function of prevention of faulty connection of the couplings.

Therefore, the inventor is intended to propose an improved 60-channel connector for eliminating the mentioned defects of the conventional.

### SUMMARY OF THE INVENTION

This invention relates to an improved 60-channel connector for solving some problems occurred in the conventional.

The primary objective of this invention is to improve the pins of 60-channel connector from the flat to the cylindrical so as to decrease the pitch between pins and raise the signal quality. Further, as the pins in a male coupling and the plugholes in a female coupling of the connector are horizontally and zigzag aligned in corresponding arrays, therefore, any faulty connection of the couplings can be prevented.

In order to realize the objective, a 60-channel connector of this invention comprises at least a male and a female coupling. The connector is characterized in: the male coupling having a D-shaped open connection base at its front end, in which metallic conductive lines for signal transmission are arranged and extended outwardly from the D-shaped mouth thereof to form a plurality of circular pins; the female coupling having a connection base with a D-shaped flange extended at its front end, in which the D-shaped flange is a sleeve-jointing structure for tight connection with the D-shaped inner verge of the male coupling, and is provided with a plurality of plugholes penetrating outwardly to match with the pins, in which a conductive wire is concealed for signal transmission through the connection base. Besides, as the pins of the male coupling and the plugholes of the female coupling are zigzag and horizontally arranged in corresponding respective arrays, prevention of faulty connection of the couplings is possible.

For more detailed information regarding advantages or features of this invention, at least an example of preferred embodiment will be fully described below with reference to the annexed drawings.

### BRIEF DESCRIPTION OF THE DRAWINGS

The related drawings in connection with the detailed description of this invention to be made later are described briefly as follows, in which:

FIG. 1 shows a conventional structure of 60-channel connector in exploded three-dimensional view;

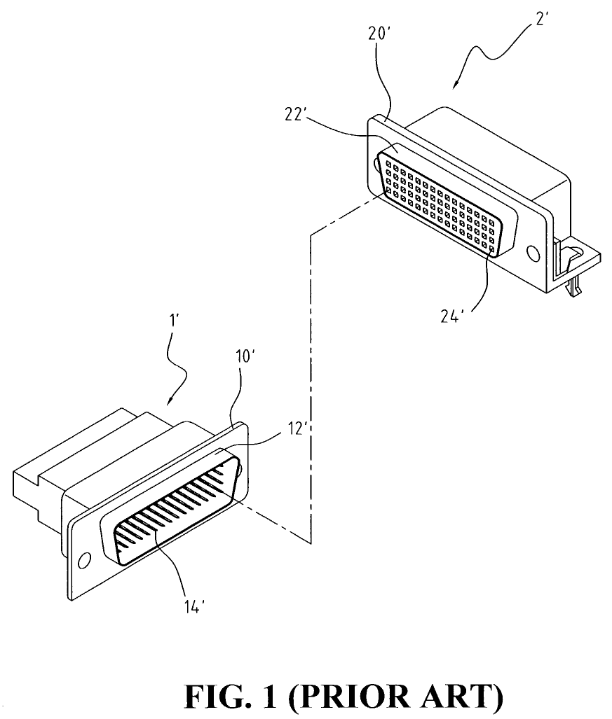

FIG. 2 shows the front view of a male coupling of the conventional 60-channel connector;

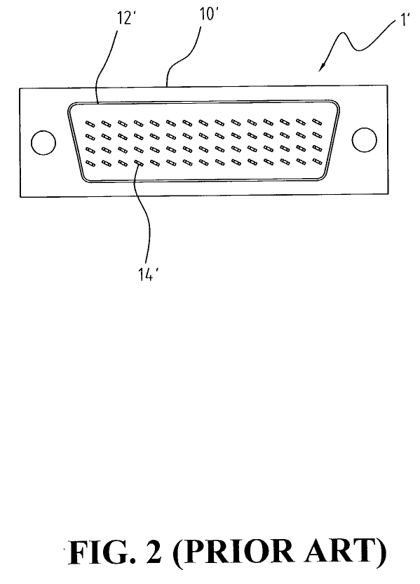

FIG. 3 shows the front view of a female coupling of the conventional 60-channel connector;

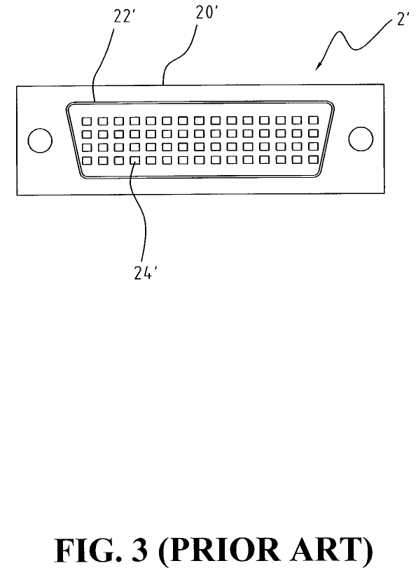

FIG. 4 shows an improved structure of 60-channel connector of this invention in exploded three-dimensional view;

FIG. 5 shows the front view of a male coupling of the 60-channel connector of this invention; and

FIG. 6 shows the front view of a female coupling of the 60-channel connector of this invention.

### DETAILED DESCRIPTION OF THE INVENTION

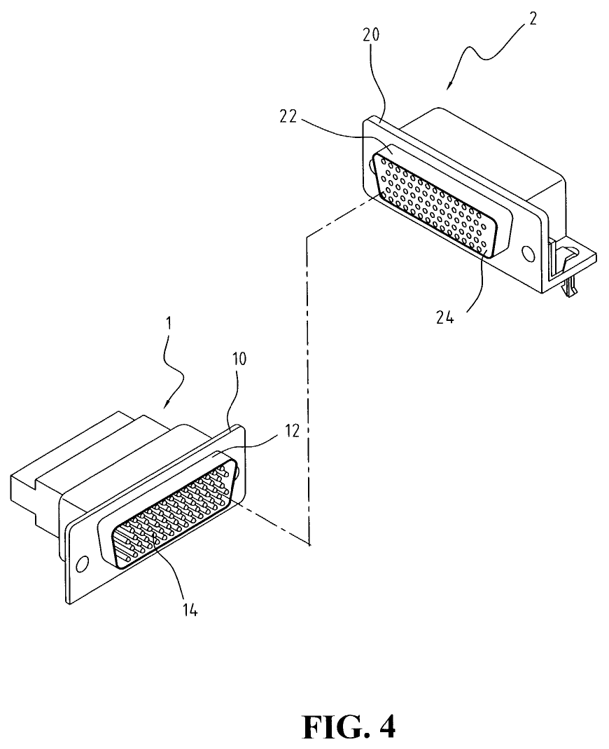

As indicated in FIGS. 4, 5, and 6, according to a preferred embodiment of this invention, an improved structure of 60-channel connector is comprised of a male coupling 1 and a female coupling 2.

The male coupling 1 is obtained by extending the front end of a connection base 10 to form a D-shaped opening 12, to which some metallic conductive lines for signal transmission are provided and extended outwardly from inside thereof to form a plurality of pins 14.

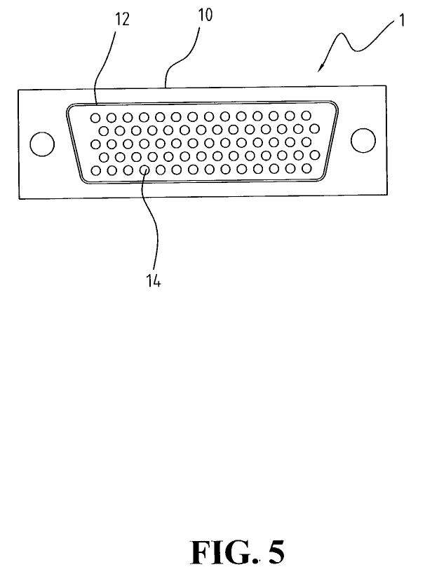

The pins 14 are zigzag and horizontally aligned in an array as shown in FIG. 5.

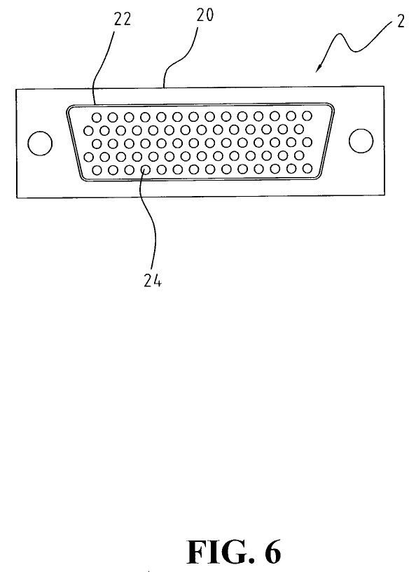

The female coupling 2 mainly consists of an open D-flange 22 formed by extending the front end of a connection base 20. The D-flange 22 is a sleeve-jointing structure meant to match exactly with the inner verge of the D-shaped opening 12 of the coupling 1, and is perforated outwardly to form a plurality of plugholes 24 zigzag and horizontally arranged in an array, corresponding to the pins 14 one to one as shown in FIG. 6, in which a metallic conductive wire is concealed in each plughole 24 respectively through the connection base 20.

The plurality of pins 14 is all of cylindrical type, and each plughole 24 shall be paired with each pin 14 to configure a butt-joint structure. Therefore, in the case the male and the female couplings are to be jointed face-to-face in an improper manner, the zigzag and horizontally arranged pins 14 and plugholes 24 will prohibit the faulty connection as a second protective layer, in addition to the first protective layer—the D-shaped opening 12 and D-shaped flange 22.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A 60-channel connector, comprising:
a male coupling in form of an opening configured by extending the front end of a connection base, in which a plurality of metallic conductive lines for signal transmission is disposed and extended outwardly from inside of said opening to form a plurality of pins; and
a female coupling in form of a flange configured by extending the front end of a connection base, in which said flange is a sleeve-jointing structure meant to match exactly with the inner verge of the opening of said male coupling and is penetrated outwardly and formed with a plurality of plugholes; and in each of the plugholes, a metallic conductive wire is concealed for signal transmission through said connection base; in which
the plurality of said pins and said plugholes are zigzag and horizontally aligned in respective arrays in the manner that said plugholes are positioned corresponding to said pins on a one-to-one basis; the pins and the plugholes are 60 pieces total respectively, and the pin is shaped cylindrically and the plughole is formed matching with the pin to become a butt-jointing structure.

2. The connector according to claim 1, in which said pins and said plugholes are zigzag and horizontally aligned in respective arrays of 4×15 and positioned correspondingly on a one-to-one basis.
